(19) United States
(12) Patent Application Publication
(10) Pub. No.: US 2025/0253421 A1
(43) Pub. Date: Aug. 7, 2025

(54) ELECTROCHROMIC INDICATOR FOR BATTERY HEALTH INFORMATION

(71) Applicant: Ford Global Technologies, LLC, Dearborn, MI (US)

(72) Inventors: Amy Christian, Plymouth, MI (US); Claudia Jazowski, Ferndale, MI (US)

(21) Appl. No.: 18/434,070

(22) Filed: Feb. 6, 2024

(51) Int. Cl. H01M 10/48; G02F 1/1524; H01M 50/105; H01M 50/124; H01M 50/211

(52) U.S. Cl. CPC H01M 10/488; G02F 1/1524; H01M 10/482; H01M 50/105; H01M 50/1245; H01M 50/211

(57) ABSTRACT

A system includes system includes at least one cell stack including one or more battery cells and an electrochromic indicator associated with one or more battery cells. A visual system monitors each electrochromic indicator.

### TECHNICAL FIELD

This disclosure relates generally to a system that is used to monitor the health of a high-voltage battery, and more specifically relates to a system that uses an electrochromic indicator to monitor battery cell health.

### BACKGROUND

Electrified vehicles are one type of vehicle that reduce automotive fuel consumption and emissions. In general, electrified vehicles differ from conventional motor vehicles, which are driven by internal combustion engines, because the electrified vehicles are selectively driven by one or more battery powered electric machines. A high voltage traction battery pack typically powers the electric machines and other electrical loads of the electrified vehicle. The traction battery pack may include one or more groupings of interconnected battery cells. Monitoring systems may be used to monitor cell characteristics of the traction battery pack.

### SUMMARY

A system according to an exemplary aspect of the present disclosure includes, among other things: at least one cell stack including one or more battery cells; an electrochromic indicator associated with one or more battery cells; and a visual system that monitors each electrochromic indicator.

In a further non-limiting embodiment of the foregoing system, the electrochromic indicator is associated with each battery cell.

In a further non-limiting embodiment of any of the foregoing systems, the electrochromic indicator comprises a tungsten oxide material.

In a further non-limiting embodiment of any of the foregoing systems, the electrochromic indicator comprises a coating with an electrochromic material that is applied to a surface of the one or more battery cells.

In a further non-limiting embodiment of any of the foregoing systems, each battery cell is comprised of a pouch material, and wherein the electrochromic indicator comprises an electrochromic material that is integrated into the pouch material of the one or more battery cells.

In a further non-limiting embodiment of any of the foregoing systems, the electrochromic indicator comprises an indicator body comprising an electrochromic material with a metal strip connecting tab terminals associated with the one or more battery cells.

In a further non-limiting embodiment of any of the foregoing systems, the electrochromic indicator is comprised of a material that changes in color or opacity in response to an electrical stimulus.

In a further non-limiting embodiment of any of the foregoing systems, the one or more battery cells have a predefined voltage range with a minimum voltage and a maximum voltage, and wherein the material changes color when a voltage is at or falls below the minimum voltage and/or the voltage is at or exceeds the maximum voltage.

In a further non-limiting embodiment of any of the foregoing systems, the material changes to a first color when the voltage of the one or more battery cells is at or falls below the minimum voltage and wherein the material changes to a second color when the voltage of the one or more battery cells is at or exceeds the maximum voltage.

In a further non-limiting embodiment of any of the foregoing systems, the voltage of the one or more battery cells varies over time, and wherein, when the voltage is at or falls below the minimum voltage and/or the voltage is at or exceeds the maximum voltage, a color change of the material remains permanent.

In a further non-limiting embodiment of any of the foregoing systems, the visual system comprises one or more cameras, and including one or more controllers receiving data from the one or more cameras.

In a further non-limiting embodiment of any of the foregoing systems, the one or more controllers are configured to generate a notice when the voltage is at or falls below the minimum voltage and/or the voltage is at or exceeds the maximum voltage.

In a further non-limiting embodiment of any of the foregoing systems, the at least one cell stack comprises a plurality of cell stacks for a battery pack, and wherein the electrochromic indicator is permanently associated with the one or more battery cells.

A method according to another exemplary aspect of the present disclosure includes, among other things: providing at least one cell stack including one or more battery cells; associating an electrochromic indicator with one or more battery cells; and visually monitoring each electrochromic indicator.

In a further non-limiting embodiment of the foregoing method, the method further includes electrically stimulating a material of the electrochromic indicator, and visually monitoring the material for changes in color, and wherein the material changes to a first color when a voltage of the one or more battery cells is at or falls below a minimum voltage and/or wherein the material changes to a second color when the voltage of the one or more battery cells is at or exceeds a maximum voltage.

In a further non-limiting embodiment of any of the foregoing methods, the method further includes generating a notice when the voltage is at or falls below the minimum voltage and/or the voltage is at or exceeds the maximum voltage.

In a further non-limiting embodiment of any of the foregoing methods, the voltage of the one or more battery cells varies over time, and wherein, when the voltage is at or falls below the minimum voltage and/or the voltage is at or exceeds the maximum voltage, a color change of the material remains permanent.

In a further non-limiting embodiment of any of the foregoing methods, the method further includes providing a visual system to include one or more cameras, and including one or more controllers receiving data from the one or more cameras to identify color changes of the material, and including:
storing the at least one cell stack in a storage facility and visually monitoring the electrochromic indicator of the one or more battery cells with the one or more cameras over time;
conveying the at least one cell stack for assembly into a vehicle and visually monitoring the electrochromic indicator of the one or more battery cells with the one or more cameras during conveyance; or
sending the at least one cell stack to a testing facility or a recycling facility, and visually monitoring the electrochromic indicator of the one or more battery cells with the one or more cameras at the testing facility or the recycling facility.

In a further non-limiting embodiment of any of the foregoing methods, the at least one cell stack comprises a plurality of cell stacks for a battery pack, and the method includes permanently associating the electrochromic indicator with each battery cell.

In a further non-limiting embodiment of any of the foregoing methods, the electrochromic indicator comprises an electrochromic material and the method includes:
applying a coating with the electrochromic material to a surface of the one or more battery cells;
forming each battery cell of a pouch material, and integrating the electrochromic material into the pouch material of the one or more battery cells; or
forming an indicator body comprising the electrochromic material with a metal strip that connects tab terminals associated with the one or more battery cells.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates an electrified vehicle.

FIG. 2 illustrates a traction battery pack of the electrified vehicle of FIG. 1.

FIG. 3 illustrates a cell stack of the traction battery pack of FIG. 2.

FIG. 4 schematically illustrates one example of a health monitoring system.

FIG. 5 schematically illustrates another example of a health monitoring system.

FIG. 6A schematically illustrates one example of a battery cell in a first condition.

FIG. 6B schematically illustrates one example of a battery cell in a second condition.

FIG. 6C schematically illustrates one example of a battery cell in a third condition.

FIG. 7 schematically illustrates one example of a battery cell with a coating including an electrochromic material.

FIG. 8 schematically illustrates one example of an electrochromic indicator that is attached to a battery cell.

### DETAILED DESCRIPTION

This disclosure details a system that uses an electrochromic indicator to monitor battery health. An exemplary system may comprise a battery pack comprising at least one cell stack including one or more battery cells, an electrochromic indicator associated with one or more battery cells, and a visual system that monitors each electrochromic indicator. These and other features are discussed in greater detail in the following paragraphs of this detailed description.

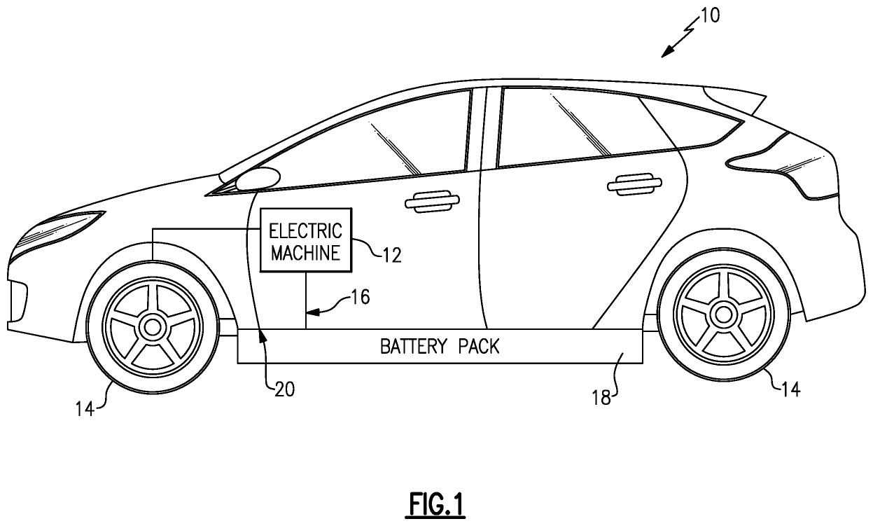

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

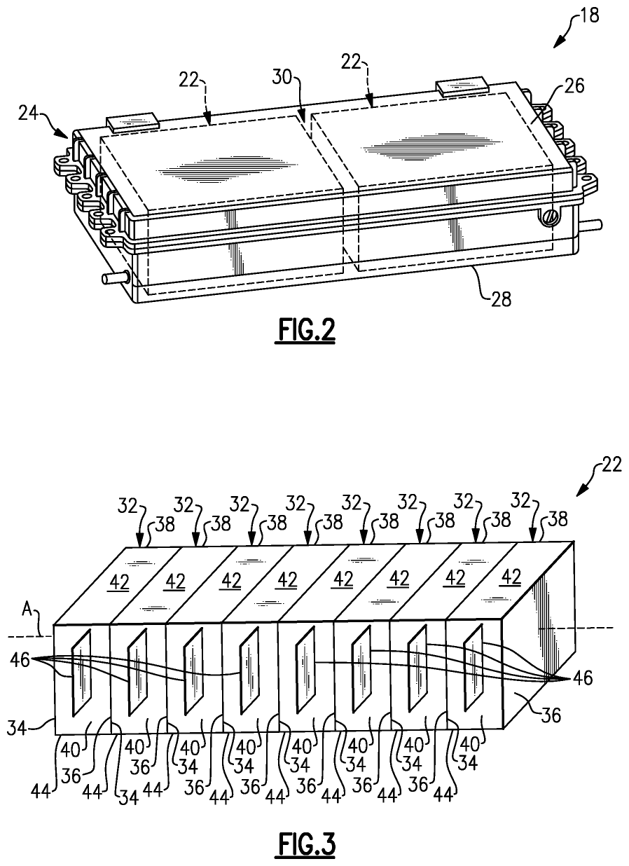

FIGS. 2 and 3 illustrate additional details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components (e.g., busbars, control modules and other electronics, etc.) of the traction battery pack 18. The size, shape, and configuration of the enclosure assembly 24 may vary within the scope of this disclosure.

Each cell stack 22 may include a plurality of individual battery cells 32 (see FIG. 3). The battery cells 32 store and supply electrical power for powering various components in order to support the electric propulsion of the electrified vehicle 10.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

Although a specific number of cell stacks 22 and battery cells 32 are illustrated in the various figures of this disclosure, the traction battery pack 18 could include any number of the cell stacks 22, with each cell stack 22 having any number of individual battery cells 32.

Each battery cell 32 may include a first face 34, a second face 36 opposite the first face 34, a first end 38, a second end 40 opposite the first end 38, a top side 42, and a bottom side 44 opposite the top side 42. The first face 34 and the second face 36 establish major side surfaces of the battery cells 32, and the first end 38, the second end 40, the top side 42, and the bottom side 44 establish minor side surfaces of the battery cell 32. The first face 34 and the second face 36 therefore exhibit a greater surface area than any of the first end 38, the second end 40, the top side 42, and the bottom side 44.

The battery cells 32 of each cell stack 22 may be stacked side-by-side relative to one another along a cell stack axis A (see FIG. 3). The battery cells 32 may be arranged such that the faces 34, 36 of one battery cell 32 are in direct contact with one of the faces 34 or 36 of a neighboring battery cell 32 of the cell stack 22. The battery cells 32 may be held in compression relative to one another within the cell stack 22 to provide the face-to-face cell arrangement. The compression may be applied by a support structure (not shown) of the cell stack 22, for example. However, other configurations are contemplated within the scope of this disclosure. The support structure may include any combination of plates, walls, crossmembers, beams, bindings, etc.

A tab terminal 46 may project outwardly from each of the first end 38 and the second end 40 of the battery cells 32. The battery cells 32 may thus be considered to be “side-oriented” within the cell stacks 22. The tab terminals 46 may be connected to busbars (not shown) in order to electrically connect the battery cells 32 of each cell stack 22.

Monitoring a state of health of each battery cell 32 is important to detect operational related issues. For example, changes in voltage may indicate an issue with the associated battery cell 32. When assembling individual battery cells 32 or arrays into a pack 18, it is important that all battery cells 32 are at the same open circuit voltage (OCV)/state of charge (SOC) to allow for the most efficient performance of the system. Further, monitoring the battery cells 32 between manufacturing, formation, and assembly may decrease expenses by preventing a non-conforming cell from entering the pack 18. Similarly, at an end of life, it is difficult to know a history of a battery cell 32 and exposure to high voltage will determine whether the battery cell 32 may be recycled or re-used for a second life.

In one example, a visual monitoring system 60 is used to monitor a health of battery cells 32 as shown in FIG. 4. In one example, one or more cell stacks 22 include one or more battery cells 32 with an electrochromic indicator 62 associated with the one or more battery cells 32, and with a visual system 64 that monitors each electrochromic indicator 62. In the example shown in FIG. 4 there are four cell stacks 22 that each have fourteen battery cells 32; however, it should be understood that any number of stacks 22 and/or cells 32 could be used.

In one example, the electrochromic indicator 62 is associated with each battery cell 32.

In one example, the electrochromic indicator 62 is comprised of a material that changes in color or opacity in response to an electrical stimulus. For example, the material can change in color due to a voltage being applied. As known, voltage, e.g., an electromotive force, comprises an energy per unit charge, i.e., voltage is a difference in electric potential between two points. In one example, the materials with electrochromic properties are metal oxides of transition, in particular WO₃, MoO₃, IrO₂, NiO, and V₂O₅. In one example, the electrochromic material comprises tungsten oxide WO₃.

FIG. 4 shows an example where a set of cell stacks 22 is being stored on a shelf or in a container/crate 50 in a storage facility. The visual system 64 visually monitors the electrochromic indicator 62 for each battery cell 32 by line of sight 52 to identify any change in color.

FIG. 5 shows an example where battery cells 32 are being transferred via a conveyor 66 for assembly purposes. Again, the visual system 64 visually monitors the electrochromic indicator 62 for each battery cell 32 by line of sight 52 to identify any change in color.

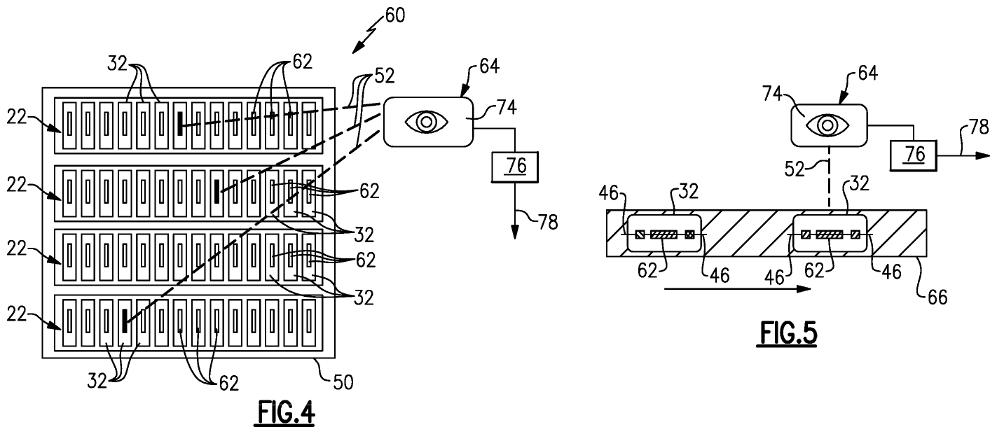

FIGS. 6A-6C show examples of color changes that are associated with the battery cells 32. FIG. 6A schematically illustrates one example of a battery cell 32 in a first condition, and FIG. 6B schematically illustrates one example of a battery cell in a second condition. As shown in FIG. 6C, for each battery cell 32 there is a predefined voltage range 68 with a minimum voltage 70 and a maximum voltage 72. In one example, the material changes color when a voltage is at or falls below the minimum voltage 70 and/or the voltage is at or exceeds the maximum voltage 72. For example the predefined voltage range 68 can be within a range between a minimum voltage 70 of 1.2 V and a maximum voltage 72 of 4.4 V. However, it should be understood that is just one example, and that other ranges could be used based on the type of application, performance requirements, etc.

FIG. 6A shows an example where the battery cell 32 is at a color that is within the predefined voltage range 68. FIG. 6B shows an example where the battery cell 32 is at a different, second color when the voltage of the one or more battery cells is at or exceeds the maximum voltage 72. FIG. 6C shows an example where the material changes to a different, third color when the voltage of the battery cell 32 is at or falls below the minimum voltage 70.

In one example, the voltage of the one or more battery cells 32 varies over time and the visual system 64 continuously monitors the electrochromic indicator 62 for each battery cell 32 to identify any changes in color. FIG. 6C shows an example where, when the voltage is at or falls below the minimum voltage 70 and/or the voltage is at or exceeds the maximum voltage 72, the color change of the material remains permanent even though the voltage of the battery cell 32 may return to being within the predefined voltage range 68. This can be referred to as a tip indicator 94 as this is a permanent change while the center electrochromic indicator continuously changes. This allows for the identification of fluctuations above and below the predefined voltage range 68 that may have compromised the health of the battery cell 32. Thus, any compromised battery cell 32 could be removed and replaced before being assembled into a pack 18.

In one example, the visual system 64 comprises one or more cameras 74 and includes one or more controllers 76 that receive data from the one or more cameras 74. In one example, the one or more controllers 76 are configured to generate a notice signal 78 when the voltage is at or falls below the minimum voltage 70 and/or the voltage is at or exceeds the maximum voltage 72. The notice signal 78 can be, for example, an audible noise, a visual signal, or a message that is automatically communicated to someone who is responsible for monitoring a status of the battery cells 32. The message can be communicated via a visual display or smart device, for example.

In one example, the controllers 76 can include a processor, memory, and one or more input and/or output (I/O) device interface(s) that are communicatively coupled via a local interface. The local interface can include, for example but not limited to, one or more buses and/or other wired or wireless connections. Further, the controller 76 may be a hardware device for executing software, particularly software stored in memory. The controller 76 can be a custom made or commercially available processor, a central processing unit (CPU), an auxiliary processor among several processors associated with the computing device, a semiconductor based microprocessor (in the form of a microchip or chip set) or generally any device for executing software instructions.

In one example, memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. In one example, software in the memory may include one or more separate programs, each of which includes an ordered listing of executable instructions for implementing logical functions. A system component embodied as software may also be construed as a source program, executable program (object code), script, or any other entity comprising a set of instructions to be performed. The controller 76 can be configured to execute software stored within the memory, to communicate data to and from the memory, and to generally control operations of the computing device pursuant to the software. Software in memory, in whole or in part, is read by the processor, perhaps buffered within the processor, and then executed.

In one example, the electrochromic indicator 62 is permanently associated with each battery cell 32. In one example, the location of the electrochromic indicator 62 could be on a side or on a face of the cell 32. The example of FIGS. 6A-C shows an example of permanently integrated electrochromic indicators 62. Each battery cell 32 is comprised of a pouch material 80, and in this example, the electrochromic indicator 62 comprises an electrochromic material 82 that is integrated into the pouch material 80 of the battery cell 32. In one example, the electrochromic material 82 is associated with a wire 84 that electrically connects the tab terminals 46.

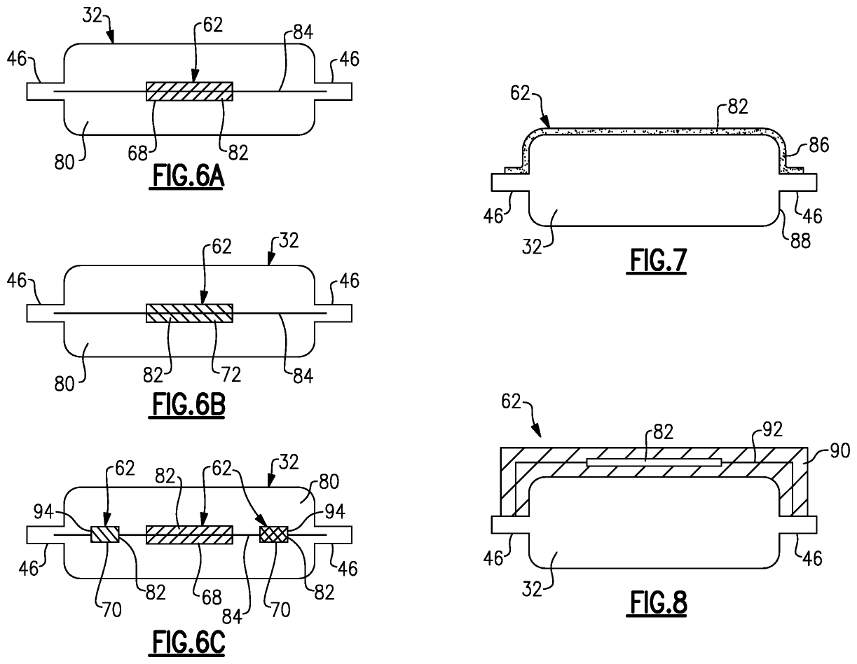

FIG. 7 shows an example where the electrochromic indicator 62 comprises a coating 86 with an electrochromic material 82 that is applied to an outer surface 88 of the battery cell 32 and electrically connects the tab terminals 46.

FIG. 8 shows an example where the electrochromic indicator 62 comprises an indicator body 90 comprising an electrochromic material 82 with a metal strip or wire 92 connecting tab terminals 46 associated with the battery cell 32.

The subject disclosure also provides for a method that includes the steps of providing at least one cell stack 22 including one or more battery cells 32, associating an electrochromic indicator 62 with one or more battery cells 32, and visually monitoring each electrochromic indicator 62.

The method may also include any of the following steps either alone or in any combination. For example, the method may include electrically stimulating a material 82 of the electrochromic indicator 62, and visually monitoring the material 82 for changes in color, and wherein the material 82 changes to a first color when a voltage of the one or more battery cells 32 is at or falls below a minimum voltage and/or wherein the material 82 changes to a second color when the voltage of the one or more battery cells 32 is at or exceeds a maximum voltage.

For example, the method may include generating a notice 78 when the voltage is at or falls below the minimum voltage and/or the voltage is at or exceeds the maximum voltage.

For example, the method may include the voltage of the one or more battery cells 32 varying over time, and wherein, when the voltage is at or falls below the minimum voltage and/or the voltage is at or exceeds the maximum voltage, a color change of the material 82 remains permanent.

For example, the method may include providing the visual system 64 to include one or more cameras 74, and including one or more controllers 76 receiving data from the one or more cameras 74 to identify color changes of the material 82. The method may include:
storing the at least one cell stack 22 in a storage facility and visually monitoring the electrochromic indicator 62 of the one or more battery cells 32 with the one or more cameras 74 over time;
conveying the at least one cell stack 22 for assembly into a vehicle and visually monitoring the electrochromic indicator 62 of the one or more battery cells with the one or more cameras 74 during conveyance; or
sending the at least one cell stack 22 to a testing facility or a recycling facility, and visually monitoring the electrochromic indicator 62 of the one or more battery cells 32 with the one or more cameras 74 at the testing facility or the recycling facility.

For example, the method may include permanently associating the electrochromic indicator 62 with each battery cell 32.

For example, the method may include: applying a coating 86 with the electrochromic material 82 to a surface of the one or more battery cells 32; forming each battery cell of a pouch material 80, and integrating the electrochromic material 82 into the pouch material 80 of the one or more battery cells 32; or forming an indicator body 90 comprising the electrochromic material 82 with a metal strip 92 that connects tab terminals 46 associated with the one or more battery cells 32.

The subject disclosure uses an electrochromic material (e.g., thin-film coating, integrated with pouch material, formed as indicator body) on battery cells 32 or stacks 22 as a method of monitoring cells/arrays during storage, testing, assembly, etc., in combination with a vision system 64. This eliminates the need for cables and/or sensors to monitor OCV/SOC as with prior systems. If the cell 32 reaches a voltage that is not within a desired range, the tip indicator 94 will turn a specific color that indicates the cell 32 has experienced a voltage outside of specification levels. The tip indicator 94 will act as a quality assurance tool that can be used before shipment of cells 32 to an OEM, can be a check for an OEM prior to array or pack assembly, and can be an indicator at end-of-life of the cell's health. The subject disclosure provides for the electrochromic indicator 62 to be paired with the vision system 64 to monitor for changes in color in the cell 32 to identify any potential issues. The vision system 64 would allow for the scanning of packs/arrays in a more efficient manner rather than checking individual cells. As discussed above, the vision system 64 is a computer system that includes one or more cameras 74 and has an application or software that will take live images of the cells 32 in storage and monitor the color status. If a cell's voltage begins to rise or fall, the change in color will be captured by the camera and the software will be able to identify which cell it is and provide a notice signal for engineers to check. If cells are run on a conveyor, the camera 74 could watch the cells 32 as they go by and indicate if the status of the cell is out of bounds. It could also detect out of specification cells in storage using the vision camera.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A system comprising:
at least one cell stack including one or more battery cells;
an electrochromic indicator associated with one or more battery cells; and
a visual system that monitors each electrochromic indicator.

2. The system of claim 1, wherein the electrochromic indicator is associated with each battery cell.

3. The system of claim 1, wherein the electrochromic indicator comprises a tungsten oxide material.

4. The system of claim 1, wherein the electrochromic indicator comprises a coating with an electrochromic material that is applied to a surface of the one or more battery cells.

5. The system of claim 1, wherein each battery cell is comprised of a pouch material, and wherein the electrochromic indicator comprises an electrochromic material that is integrated into the pouch material of the one or more battery cells.

6. The system of claim 1, wherein the electrochromic indicator comprises an indicator body comprising an electrochromic material with a metal strip connecting tab terminals associated with the one or more battery cells.

7. The system of claim 1, wherein the electrochromic indicator is comprised of a material that changes in color or opacity in response to an electrical stimulus.

8. The system of claim 7, wherein the one or more battery cells have a predefined voltage range with a minimum voltage and a maximum voltage, and wherein the material changes color when a voltage is at or falls below the minimum voltage and/or the voltage is at or exceeds the maximum voltage.

9. The system of claim 8, wherein the material changes to a first color when the voltage of the one or more battery cells is at or falls below the minimum voltage and wherein the material changes to a second color when the voltage of the one or more battery cells is at or exceeds the maximum voltage.

10. The system of claim 8, wherein the voltage of the one or more battery cells varies over time, and wherein, when the voltage is at or falls below the minimum voltage and/or the voltage is at or exceeds the maximum voltage, a color change of the material remains permanent.

11. The system of claim 8, wherein the visual system comprises one or more cameras, and including one or more controllers receiving data from the one or more cameras.

12. The system of claim 11, wherein the one or more controllers are configured to generate a notice when the voltage is at or falls below the minimum voltage and/or the voltage is at or exceeds the maximum voltage.

13. The system of claim 1, wherein the at least one cell stack comprises a plurality of cell stacks for a battery pack, and wherein the electrochromic indicator is permanently associated with the one or more battery cells.

14. A method comprising:
providing at least one cell stack including one or more battery cells;
associating an electrochromic indicator with one or more battery cells; and
visually monitoring each electrochromic indicator.

15. The method of claim 14, including electrically stimulating a material of the electrochromic indicator, and visually monitoring the material for changes in color, and wherein the material changes to a first color when a voltage of the one or more battery cells is at or falls below a minimum voltage and/or wherein the material changes to a second color when the voltage of the one or more battery cells is at or exceeds a maximum voltage.

16. The method of claim 15, including generating a notice when the voltage is at or falls below the minimum voltage and/or the voltage is at or exceeds the maximum voltage.

17. The method of claim 15, wherein the voltage of the one or more battery cells varies over time, and wherein, when the voltage is at or falls below the minimum voltage and/or the voltage is at or exceeds the maximum voltage, a color change of the material remains permanent.

18. The method of claim 15, including providing a visual system to include one or more cameras, and including one or more controllers receiving data from the one or more cameras to identify color changes of the material, and including:
storing the at least one cell stack in a storage facility and visually monitoring the electrochromic indicator of the one or more battery cells with the one or more cameras over time;
conveying the at least one cell stack for assembly into a vehicle and visually monitoring the electrochromic indicator of the one or more battery cells with the one or more cameras during conveyance; or
sending the at least one cell stack to a testing facility or a recycling facility, and visually monitoring the electrochromic indicator of the one or more battery cells with the one or more cameras at the testing facility or the recycling facility.

19. The method of claim 14, wherein the at least one cell stack comprises a plurality of cell stacks for a battery pack, and including permanently associating the electrochromic indicator with each battery cell.

20. The method of claim 14, wherein the electrochromic indicator comprises an electrochromic material and including:
applying a coating with the electrochromic material to a surface of the one or more battery cells;
forming each battery cell of a pouch material, and integrating the electrochromic material into the pouch material of the one or more battery cells; or
forming an indicator body comprising the electrochromic material with a metal strip that connects tab terminals associated with the one or more battery cells.
